(19) United States
(12) Patent Application Publication
(10) Pub. No.: US 2017/0372266 A1
(43) Pub. Date: Dec. 28, 2017

(54) CONTEXT-AWARE MAP FROM ENTITIES TO CANONICAL FORMS

(71) Applicant: Linkedln Corporation, Mountain View, CA (US)

(72) Inventors: Dan Shacham, Sunnyvale, CA (US); Uri Merhav, Rehovot (IL); Qi He, San Jose, CA (US); Angela Jiang, San Francisco, CA (US)

(21) Appl. No.: 15/189,974

(22) Filed: Jun. 22, 2016

(51) Int. Cl. G06Q 10/10; G06Q 50/00; G06N 99/00

(52) U.S. Cl. CPC G06Q 10/1053; G06N 99/005; G06Q 50/01

(57) ABSTRACT

A system, a machine-readable storage medium storing instructions, and a computer-implemented method are described herein are directed to a Mapping Engine that selects a candidate job title(s) from a portion of a job title taxonomy that corresponds with a job title(s) in profile data of a target member account of a social network service. For each respective candidate job title in the plurality of candidate job titles, the Mapping Engine assembles, according to an encoded rule(s) of a machine learning model for the respective candidate job title, feature vector data based in part on profile data of the target member account. The Mapping Engine calculates a probable job title score according to the machine learning model for the respective candidate job title. The Mapping Engine identifies a select probable job title score from a plurality of probable job title scores. The Mapping Engine creates an association between the job title(s) in the profile data of the target member account and a candidate job title that corresponds to the select probable job title score.

### TECHNICAL FIELD

The present disclosure generally relates to data processing systems. More specifically, the present disclosure relates to methods, systems and computer program products identifying relationships between data and standardized data.

### BACKGROUND

A social networking service is a computer- or web-based application that enables users to establish links or connections with persons for the purpose of sharing information with one another. Some social networking services aim to enable friends and family to communicate with one another, while others are specifically directed to business users with a goal of enabling the sharing of business information. For purposes of the present disclosure, the terms “social network” and “social networking service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks”).

With many social networking services, members are prompted to provide a variety of personal information, which may be displayed in a member's personal web page. Such information is commonly referred to as personal profile information, or simply “profile information”, and when shown collectively, it is commonly referred to as a member's profile. For example, with some of the many social networking services in use today, the personal information that is commonly requested and displayed includes a member's age, gender, interests, contact information, home town, address, the name of the member's spouse and/or family members, and so forth. With certain social networking services, such as some business networking services, a member's personal information may include information commonly included in a professional resume or curriculum vitae, such as information about a person's education, employment history, skills, professional organizations, and so on. With some social networking services, a member's profile may be viewable to the public by default, or alternatively, the member may specify that only some portion of the profile is to be public by default. Accordingly, many social networking services serve as a sort of directory of people to be searched and browsed.

### DESCRIPTION OF THE DRAWINGS

Some embodiments are illustrated by way of example and not limitation in the figures of the accompanying drawings in which:

FIG. 1 is a block diagram illustrating a client-server system, in accordance with an example embodiment;

FIG. 2 is a block diagram showing functional components of a professional social network within a networked system, in accordance with an example embodiment;

FIG. 3 is a flowchart illustrating an example method, according to various embodiments;

FIG. 4 is a block diagram showing an example job title taxonomy built by a Mapping Engine, according to various embodiments;

FIG. 5 illustrates a data flow diagram of a Mapping Engine identifying a set of candidate job titles, according to various embodiments;

FIG. 6 illustrates a data flow diagram of a Mapping Engine assembling feature vectors for a candidate job title machine learning models to infer a probable job title, according to various embodiments;

FIG. 7 is a block diagram showing example components of a Mapping Engine, according to some embodiments.

FIG. 8 is a block diagram of an example computer system on which methodologies described herein may be executed, in accordance with an example embodiment.

### DETAILED DESCRIPTION

The present disclosure describes methods and systems for updating a target member account in a professional social networking service (also referred to herein as a “professional social network” or “social network” or “social network service”) based on a resource accessed by the target member account. In the following description, for purposes of explanation, numerous specific details are set forth in order to provide a thorough understanding of the various aspects of different embodiments described herein. It will be evident, however, to one skilled in the art, that one or more embodiments may be practiced without all of the specific details.

A system, a machine-readable storage medium storing instructions, and a computer-implemented method are described herein are directed to a Mapping Engine that selects a candidate job title(s) from a portion of a job title taxonomy that corresponds with a job title(s) in profile data of a target member account of a social network service. For each respective candidate job title in the plurality of candidate job titles, the Mapping Engine assembles, according to an encoded rule(s) of a machine learning model for the respective candidate job title, feature vector data based in part on profile data of the target member account. The Mapping Engine calculates a probable job title score according to the machine learning model for the respective candidate job title. The Mapping Engine identifies a select probable job title score from a plurality of probable job title scores. The Mapping Engine creates an association between the job title(s) in the profile data of the target member account and a candidate job title that corresponds to the select probable job title score.

According to exemplary embodiments, various member accounts of a social network service may have jobs with the same function and responsibilities, but will having varying job titles. Due to the different job titles, conventional systems do not categorize these member accounts according to the same standardized job title. Rather, conventional systems treat the textual difference in job titles as an indication that the member accounts have different types of jobs. The Mapping Engine provides output that results in mapping job titles of various member accounts to a standardized job title—regardless of whether the member accounts' job titles are textually different. By creating a group of member accounts that have varying job titles according to a standardized job title, the Mapping Engine can identify content, advertisements, products and recommendations that can be fed to the group of member accounts.

The Mapping Engine maps a job title in profile data of a target member account to a standardized job title in a taxonomy of job titles. The Mapping Engine builds a taxonomy of job titles based on job titles from profiles of various member accounts that share common skills. For example, a job title of “Manager” often occurs in profile data of member accounts having skills tags that represent various managerial skills. In addition, a job title of “Engineering Manager” often occurs in profile data of member accounts that also have some of the same skills tags that represent managerial skills. Therefore, based on identifying common skills tags between different job titles, the Mapping Engine determines that the different job titles—although textually different—represent similar job functions and similar roles. The Mapping Engine creates relationships between the different job titles in the taxonomy, such as a parent-child relationship. For example, the job title of “Manager” has a parent-child relationship with “Engineering Manager” in the taxonomy. The job title of “Manager” may also have additional parent-child relationships in the taxonomy with “Software Manager” and “Hospital Manager”.

The Mapping Engine identifies candidate job titles from the taxonomy for a target member account based on similarities with a job title(s) in the target member account's profile data. For example, upon identifying a portion of text present in both a job title in the target member account's profile data and a job title in the taxonomy, the Mapping Engine identifies that similar job title in the taxonomy as a candidate job title. All other job titles in the taxonomy having a respective taxonomy relationship with that similar job title are also identified as candidate job titles. The Mapping Engine creates a set of candidate job titles, where each candidate job title may ultimately be a standardized taxonomy version of the job title present in the target member account's profile data.

Each candidate job title has its own machine learning model with a distinct feature set and one or more encoded feature rules. Each feature set for a candidate job title's machine learning model is based on skills, industries, titles and previous titles that are learned as being relevant to that respective candidate job title. That is, presence of certain types of skills tags, industry descriptors and certain job titles in a member account's raw profile data is predictive of the respective candidate job title being representative of the target member account's current job title. A feature of a machine learning model is based on attributes and actions in raw data of member accounts learned by the Mapping Engine as being germane in determining a standardized job title.

For each respective candidate job title, the Mapping Engine assembles feature vector data based on the profile data of the target member account and one or more encoded feature rules. In some embodiments, the feature vector data can also be based in part on learned coefficients (such as regression coefficients) for each type of feature rule. A select candidate job title feature vector that produces a highest score represents an inference that the target member account's job title is best represented by the select candidate job title. The Mapping Engine creates an association between the job title in the target member account's profile data and the select candidate job title.

In various embodiments, each candidate job title machine learning model is built, trained and implemented according to one of various known prediction modelling techniques. Training data is used to train each machine learning model. The training process identifies the features of each model. To build and train each job title machine learning model, the Mapping Engine may perform a prediction modelling process based on a statistics-based machine learning model such as a logistic regression model. Other prediction modelling techniques may include other machine learning models such as a Naïve Bayes model, a support vector machines (SVM) model, a decision trees model, and a neural network model, all of which are understood by those skilled in the art.

According to various exemplary embodiments, the Mapping Engine may be executed for the purposes of both off-line training (for generating, training, and refining each machine learning model) and online processing for identifications of select candidate job titles as being standardized versions of job titles in profile data of respective member accounts.

According to various exemplary embodiments, the Mapping Engine may be used for the purposes of both offline pre-processing creation and updating of a taxonomy of job titles, as well as online mapping of a standardized taxonomy job title to a job title in profile data of target member account.

As described in various embodiments, the Mapping Engine may be a configuration-driven system for building, training, and deploying models for creating job title mapping associations. In particular, the operation of the Mapping Engine is completely configurable and customizable by a user through a user-supplied configuration file such as a JavaScript Object Notation (JSON), eXtensible Markup Language (XML) file, etc.

For example, each module in the Mapping Engine may have text associated with it in a configuration file(s) that describes how the module is configured, the inputs to the module, the operations to be performed by the module on the inputs, the outputs from the module, and so on. Accordingly, the user may rearrange the way these modules are connected together as well as the rules that the various modules use to perform various operations. Thus, whereas conventional prediction modeling is often performed in a fairly ad hoc and code driven manner, the modules of the Mapping Engine may be configured in a modular and reusable fashion, to enable more efficient job title mapping.

It is understood that various embodiments further include encoded instructions that comprise operations to generate a user interface(s) and various user interface elements. The user interface and the various user interface elements can be displayed to be representative of any of the operations, profile data, models, taxonomy, feature data and job title mappings, as described herein. In addition, the user interface and various user interface elements are generated by the Mapping Engine for display on a computing device, a server computing device, a mobile computing device, etc.

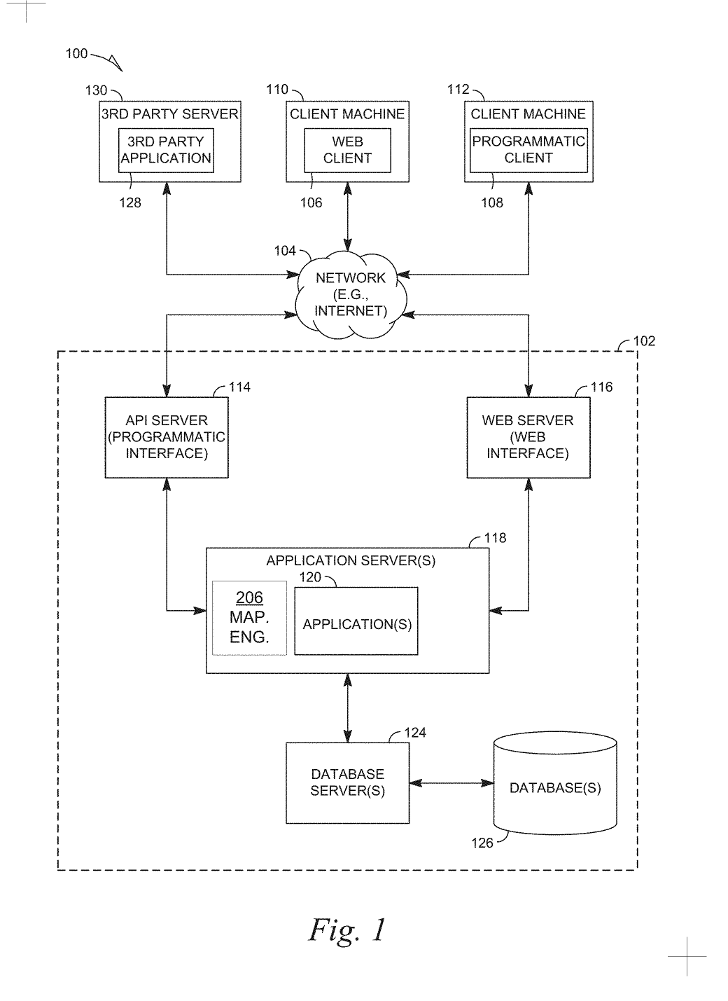

Turning now to FIG. 1 is a block diagram illustrating a client-server system, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102. In some embodiments, the networked system 102 may comprise functional components of a professional social network.

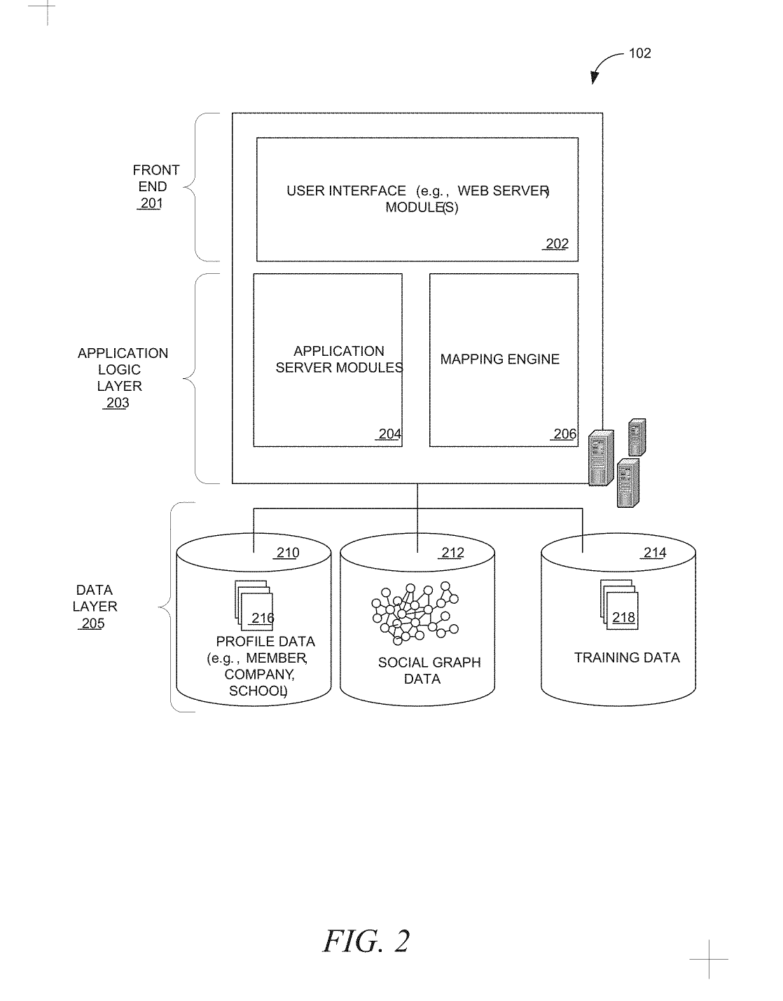

FIG. 2 is a block diagram showing functional components of a professional social network within the networked system 102, in accordance with an example embodiment.

As shown in FIG. 2, the professional social network may be based on a three-tiered architecture, consisting of a front-end layer 201, an application logic layer 203, and a data layer 205. In some embodiments, the modules, systems, and/or engines shown in FIG. 2 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 2. However, one skilled in the art will readily recognize that various additional functional modules and engines may be used with a professional social network, such as that illustrated in FIG. 2, to facilitate additional functionality that is not specifically described herein. Furthermore, the various functional modules and Mapping Engine 206 depicted in FIG. 2 may reside on a single server computer, or may be distributed across several server computers in various arrangements. Moreover, although a professional social network is depicted in FIG. 2 as a three-tiered architecture, the inventive subject matter is by no means limited to such architecture. It is contemplated that other types of architecture are within the scope of the present disclosure.

As shown in FIG. 2, in some embodiments, the front-end layer 201 comprises a user interface module (e.g., a web server) 202, which receives requests and inputs from various client-computing devices, and communicates appropriate responses to the requesting client devices. For example, the user interface module(s) 202 may receive requests in the form of Hypertext Transport Protocol (HTTP) requests, or other web-based, application programming interface (API) requests.

In some embodiments, the application logic layer 203 includes various application server modules 204, which, in conjunction with the user interface module(s) 202, generates various user interfaces (e.g., web pages) with data retrieved from various data sources in the data layer 205. In some embodiments, individual application server modules 204 are used to implement the functionality associated with various services and features of the professional social network. For instance, the ability of an organization to establish a presence in a social graph of the social network service, including the ability to establish a customized web page on behalf of an organization, and to publish messages or status updates on behalf of an organization, may be services implemented in independent application server modules 204. Similarly, a variety of other applications or services that are made available to members of the social network service may be embodied in their own application server modules 204.

As shown in FIG. 2, the data layer 205 may include several databases, such as a database 210 for storing profile data 216, including both member profile attribute data as well as profile attribute data for various organizations. Consistent with some embodiments, when a person initially registers to become a member of the professional social network, the person will be prompted to provide some profile attribute data such as, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information may be stored, for example, in the database 210. Similarly, when a representative of an organization initially registers the organization with the professional social network the representative may be prompted to provide certain information about the organization. This information may be stored, for example, in the database 210, or another database (not shown). With some embodiments, the profile data 216 may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or a seniority level within a particular company. With some embodiments, importing or otherwise accessing data from one or more externally hosted data sources may enhance profile data 216 for both members and organizations. For instance, with companies in particular, financial data may be imported from one or more external data sources, and made part of a company's profile.

The profile data 216 may also include information regarding settings for members of the professional social network. These settings may comprise various categories, including, but not limited to, privacy and communications. Each category may have its own set of settings that a member may control.

As members interact with the various applications, services and content made available via the professional social network, the members' behaviour (e.g., content viewed, links or member-interest buttons selected, etc.) may be monitored and information 218 concerning the member's activities and behaviour may be stored, for example, as indicated in FIG. 2, by the database 214. This information 218, along with portions of the profile data 216, can be training data used by the Mapping Engine 206 to train machine learning models for each job title in a job title taxonomy and to identify a feature(s) for a respective machine learning model.

Once registered, a member may invite other members, or be invited by other members, to connect via the professional social network. A “connection” may be formed from a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed or content stream. In any case, the various associations and relationships that the members establish with other members, or with other entities and objects, may be stored and maintained as social graph data within a social graph database 212.

The professional social network may provide a broad range of other applications and services that allow members the opportunity to share and receive information, often customized to the interests of the member. For example, with some embodiments, the professional social network may include a photo sharing application that allows members to upload and share photos with other members. With some embodiments, members may be able to self-organize into groups, or interest groups, organized around a subject matter or topic of interest. With some embodiments, the professional social network may host various job listings providing details of job openings with various organizations.

In some embodiments, the professional social network provides an application programming interface (API) module via which third-party applications can access various services and data provided by the professional social network. For example, using an API, a third-party application may provide a user interface and logic that enables an authorized representative of an organization to publish messages from a third-party application to a content hosting platform of the professional social network that facilitates presentation of activity or content streams maintained and presented by the professional social network. Such third-party applications may be browser-based applications, or may be operating system-specific. In particular, some third-party applications may reside and execute on one or more mobile devices (e.g., a smartphone, or tablet computing devices) having a mobile operating system.

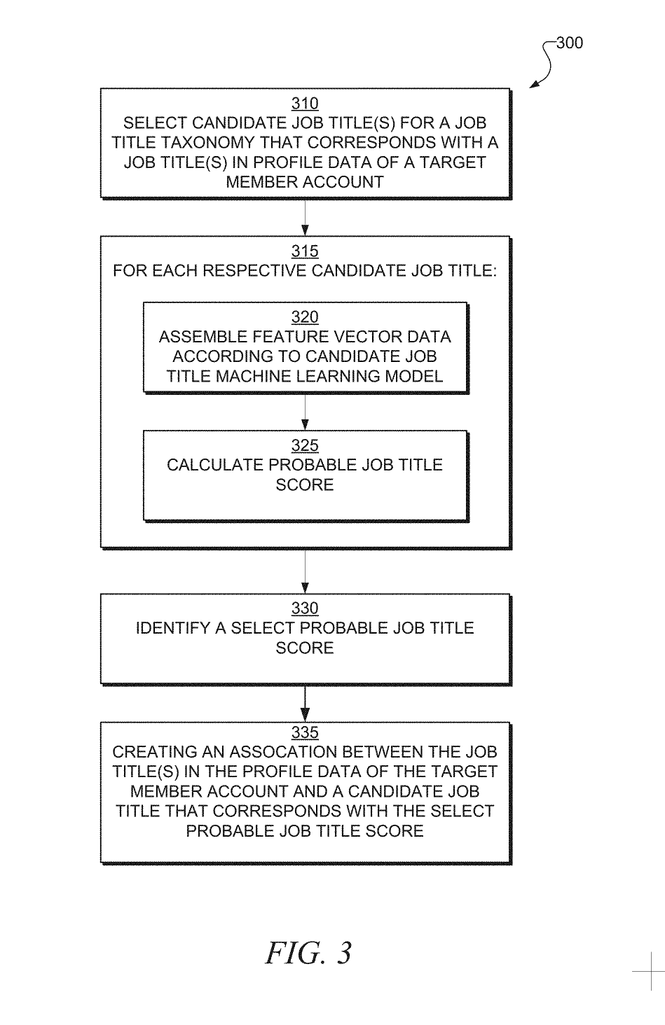

The data in the data layer 205 may be accessed, used, and adjusted by the Mapping Engine 206 as will be described in more detail below in conjunction with FIGS. 3-8. Although the Mapping Engine 206 is referred to herein as being used in the context of a professional social network, it is contemplated that it may also be employed in the context of any website or online services, including, but not limited to, content sharing sites (e.g., photo- or video-sharing sites) and any other online services that allow users to have a profile and present themselves or content to other users. Additionally, although features of the present disclosure are referred to herein as being used or presented in the context of a web page, it is contemplated that any user interface view (e.g., a user interface on a mobile device or on desktop software) is within the scope of the present disclosure.

FIG. 3 is a flowchart illustrating an example method 300, according to various embodiments.

At operation 310, the Mapping Engine 260 selects a candidate job title(s) from a portion of a job title taxonomy that corresponds with a job title in profile(s) data of a target member account of a social network service. For example, the identifies textual similarities, such as a shared text segment, between the target member account's job title and a job title(s) in the job title taxonomy.

Upon identifying a similar job title in the job title taxonomy, the Mapping Engine 260 selects adjacent job titles in the job title taxonomy. For example, the Mapping Engine 260 applies one or more connection thresholds with respect to the similar job title to select additional candidate job titles in the in the job title taxonomy. A connection threshold may represent one or more of the following: how many levels up and down in the job title taxonomy from which additional candidate job titles can be selected, a maximum number of additional candidate job titles to be selected, and how many additional candidate job titles having parent-child relationships in the job title taxonomy can be identified for selection.

At operation 315, the Mapping Engine 260, executes operations 320-325 for each respective candidate job title in the plurality of candidate job titles.

At operation 320, the Mapping Engine 260 assembles, according to an encoded rule(s) of a machine learning model for the respective candidate job title, feature vector data based in part on profile data of the target member account.

The Mapping Engine 206 utilizes a machine learning model for each job title in the job title taxonomy. Each machine learning model includes a distinct set of encoded rules and a set of pre-defined features for converting a member account's raw data and attributes into feature vector data.

The Mapping Engine 206 assembles feature vector data in order for a machine learning model, implemented via one or more data structures, to calculate an output representing a probability that a job title present in the target member account's raw data is best represented by a standardized job title that corresponds with the machine learning model that calculates the output. For example—for each machine learning model—the Mapping Engine 206 accesses encoded data representative of a feature rule(s) for a type of pre-defined feature. The Mapping Engine 206 accesses encoded data representative of an attribute(s) of the target member account that corresponds with the type of the pre-defined feature. The Mapping Engine 206 identifies a learned coefficient associated with the type of the pre-defined feature. The Mapping Engine 206 assembles, according to the feature rule, a portion of feature vector data for the target member account based on the attribute(s) and raw data of the target member account and the learned coefficient associated with the type of the pre-defined feature.

At operation 325, the Mapping Engine 260 calculates a probable job title score according to the machine learning model for the respective candidate job title. For example, each respective candidate job title's machine learning model calculates a probable job title score.

At operation 330, the Mapping Engine 260 identifies a select probable job title score from a plurality of probable job title scores. For example, the Mapping Engine 206 compares a threshold score to each probable job title score. If the threshold score is met or exceeded by a particular probable job title score, the Mapping Engine 206 infers that a standardized version of the target member account's job title is best represented by the candidate job title associated with the probable job title score that meets or exceeds the threshold score. In various embodiments, each machine learning model is associated with a unique threshold score.

At operation 335, the Mapping Engine 260 creates an association between the at least one job title in the profile data of the target member account and a candidate job title that corresponds to the select probable job title score.

According to various embodiments, it is understood that each machine learning model is a logistic regression model. As understood by those skilled in the art, logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event (or action) given a set of independent/predictor variables.

The independent/predictor variables of each machine learning model are the attributes represented by assembled feature vectors based on the types of features described throughout. Regression coefficients for each type of feature may be estimated using maximum likelihood or learned through a supervised learning technique from data collected in logged training data or calculated from log data describing data and attributes that correspond to job titles, skills tags, industry descriptors, education attributes, length of employment time periods, employer identifications, geographic locations, and job function descriptions.

Accordingly, once the appropriate regression coefficients are determined, the features are inserted into various data locations in order to assemble a respective feature vector for each machine learning model. A first feature vector may be input into a first machine learning model in order to calculate a first probable job title score. A second feature vector may be input into a second machine learning model in order to calculate a second probable job title score. Stated differently, an assembled feature vector for the target member account is based on various types of feature rules and regression feature coefficients of respective machine learning models. The features are based on types of raw account data and member account attributes.

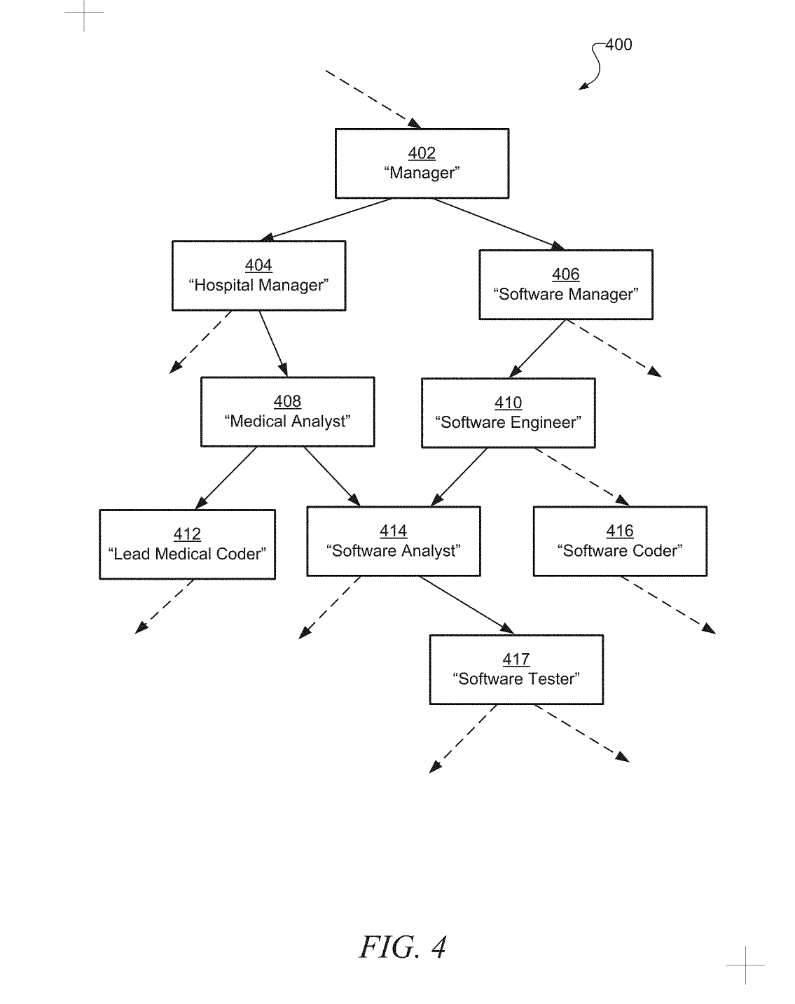

FIG. 4 is a block diagram showing an example job title taxonomy built by a Mapping Engine 206, according to various embodiments.

In an offline pre-processing mode, the Mapping Engine 206 builds a job title taxonomy 400 by creating taxonomy relationships between various candidate job titles 402, 404, 406, 408, 410, 412, 414, 416, 417 . . . . The Mapping Engine 206 identifies member accounts that have different job titles in the raw profile data but also share common skills tags. The shared common skills tags is an indication that the member accounts have related job functions even though their job titles are different.

The Mapping Engine 206 identifies a first plurality of member accounts of the social network service with respective raw profile data that includes a first job title. The Mapping Engine 206 identifies a first plurality of skills commonly occurring in the respective profile data of the first plurality of member accounts. For example, the Mapping Engine 206 identifies various member accounts with a job title of “Software Manager” and each of these member accounts have at least the skills tags of “Program Management”, Software Development”, and “Project Management”.

The Mapping Engine 206 identifies a second plurality of member accounts of the social network service with respective profile data that includes a second job title. The Mapping Engine 206 identifies a first plurality of skills commonly occurring in the respective profile data of the first plurality of member accounts. For example, the Mapping Engine 206 identifies various member accounts with a job title of “Manager” and each of these member accounts have at least the skills tags of “Program Management”, “Project Management”, “Data Analysis” and “Strategic Planning”. The Mapping Engine 206 identifies that a threshold number of skills tags are shared between those member accounts having either the job title “Manager” 402 or the job title “Software Manager” 406. The Mapping Engine 206 creates a taxonomy relationship between the job title “Manager” 402 and the job title “Software Manager” 406 based on meeting or exceeding a threshold number of shared skills tags (“Program Management”, “Project Management”). In one embodiment, the Mapping Engine 206 determines a parent node based on which job title is associated with member accounts having a larger average amount of professional work experience. It is understood that the Mapping Engine 206 can also build one or more portions of the job title taxonomy during an online mode as well. It is understood that a skills tag is a textual tag describing a type of professional skill selected by a member account to be display in the member account's profile. In some embodiment, a skills tag can be selected by another member account having a social connection with the member for display in the member account's profile.

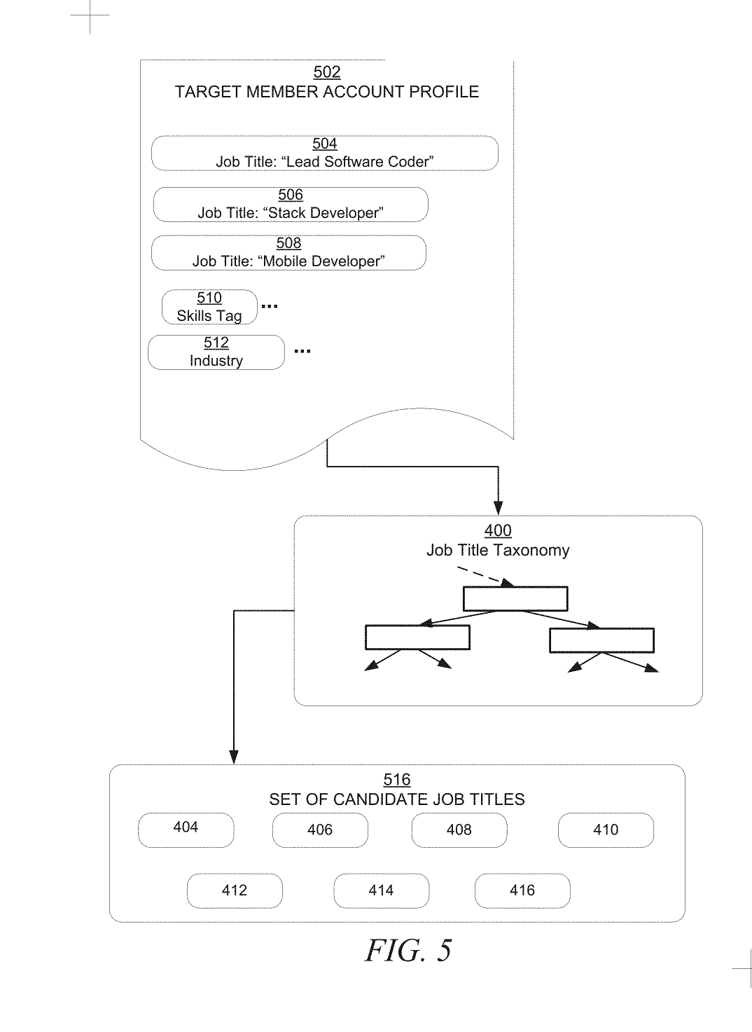

FIG. 5 illustrates a data flow diagram of a Mapping Engine 206 identifying a set of candidate job titles, according to various embodiments.

A target account member has a profile 502 that includes one or more professional attributes. The profile 502 includes a current job title 504 and previous job titles 506, 508. In addition, the profile 502 includes one or more skills tags 510 . . . selected by the target account member and other member accounts. The profile 502 includes one or more industry descriptors 512 . . . . An industry descriptor is a profile attribute that describes an industry sector related to the professional experience of the user represented by the target member account.

The Mapping Engine 206 compares one or more job titles 504, 506, 508 in the profile 502 to job titles in the job title taxonomy 400 in order to identify one or more similar job titles in the job title taxonomy 400. A similar job title in the job title taxonomy 400 shares at least a similar text portion with a job title 504 in the target member account's profile 502. For each similar job title in the job title taxonomy 400, the Mapping Engine 206 applies one or more connection thresholds to identify additional job titles that are connected to a similar job title or within a certain degree of connection (e.g., parent-child, a pre-defined node distance range) with the similar job title. The Mapping Engine 206 creates a set of candidate job titles 516 that includes “Hospital Manager” 404, “Software Manager” 406, “Medical Analyst” 408, “Software Engineer” 410, “Lead Medical Coder” 412, “Software Analyst” 414, and “Software Coder” 416 as possible standardized versions of the current job title “Lead Software Coder” 504 in the target member account's profile 502.

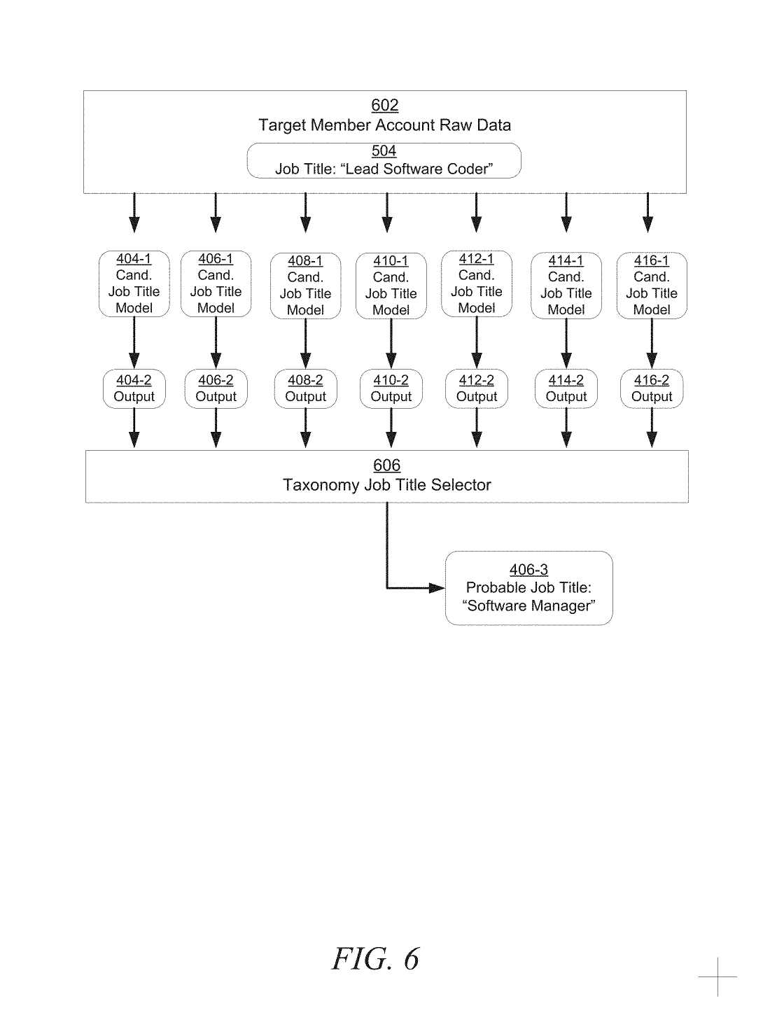

FIG. 6 illustrates a data flow diagram of a Mapping Engine 206 assembling feature vectors for a candidate job title machine learning models to infer a probable job title, according to various embodiments.

For each candidate job title in the set of candidate job titles 516, the Mapping Engine 206 accesses encoded data representative of a feature rule for a type of pre-defined feature. The Mapping Engine 206 accesses encoded data representative of an attribute(s) of the profile data 502 of the target member account that corresponds with the type of the pre-defined feature. Each encoded rule of a machine learning model further comprises a learned coefficient representing an importance of the respective pre-defined feature. The Mapping Engine 206 identifies a regression coefficient associated with the type of the pre-defined feature. Mapping Engine 206 assembles, according to the feature rule, a portion of the feature vector data for the target member account based on the attribute(s) of the profile data 502 and the regression coefficient.

For example, for each machine learning model 404-1, 406-1, 408-1, 410-1, 412-1, 414-1, 416-1 for each candidate job title 404, 406, 408, 410, 412, 414, 416, the Mapping Engine 206 accesses feature vector encoding rules describing a vector position for each type of feature that is included in the respective machine learning model's feature set. More specifically, the feature vector encoding rules may state that, for example, a feature for a skills metric is to be stored at a position X1 of a feature vector, an aggregate industry feature is to be stored a position X2, a previous job title feature is to be stored at a position X3. Thus, the resulting feature vector includes various features of the target member account's profile data 502 that is part of the target member account raw data 602 (profile attributes, browsing behaviours, transaction history, purchase history, social feed activity, network connections, etc.). In addition, the vector assembling process may involve converting a portion(s) of the raw data 602 into an internal representation (e.g., into a numerical value) for insertion into the feature vector, based on the feature vector encoding rules. It is understood that a feature vector is not limited to three vector positions and that a feature vector can be assembled according to any number of pre-defined features having their own assigned vector position.

Each machine learning model 404-1, 406-1, 408-1, 410-1, 412-1, 414-1, 416-1 generates output 404-2, 406-2, 408-2, 410-2, 412-2, 414-2, 416-2 representing a probable job title score. A probable job title score represents a likelihood calculated by a machine learning model that that a candidate job title is a standardized version of the target member account's current job title 504. For example, the machine learning model 406-1 for “Software Manager” calculates a probable job title score 406-2, that represents a likelihood calculated by the machine learning model 406-1 that “Software Manager” is a standardized version of the target member account's current job title 504 of “Lead Software Coder”. Based on determining the probable job title score 406-2 being the highest score—or meets a threshold score—the taxonomy job title selector 606 determines that “Software Manager” is a standardized version of “Lead Software Coder”. The Mapping Engine 206 creates a mapping of between the target member account profile 502 and a job title tag of “Software Manager.” For example, in one embodiment, the mapping between the target account profile 502 and the job title tag can be stored in the account raw data 602.

Therefore, according to the embodiments disclosed herein, unlike conventional systems, a taxonomy is built to represent relationships between a plurality of job titles. Machine learning models are generated and learned for each job title in the taxonomy. Member account data of a target member account and connection thresholds are used to select a subset of job titles from the taxonomy. A machine learning model that corresponds to each selected job titles in the subset of job titles is identified. One or more portions of the member account data is input into the identified machine learning models to infer which of the selected job titles is most likely an accurate standardized job title for the target member account. Based on the probable job title inferred for the target member account, the target member account can be included in a grouping of member accounts that share the same probable job title, even though their current job titles are textually different. Relevant content, notifications, advertisements and commercial offers can be sent to the grouping of member accounts based on the probable job title.

It is understood that certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

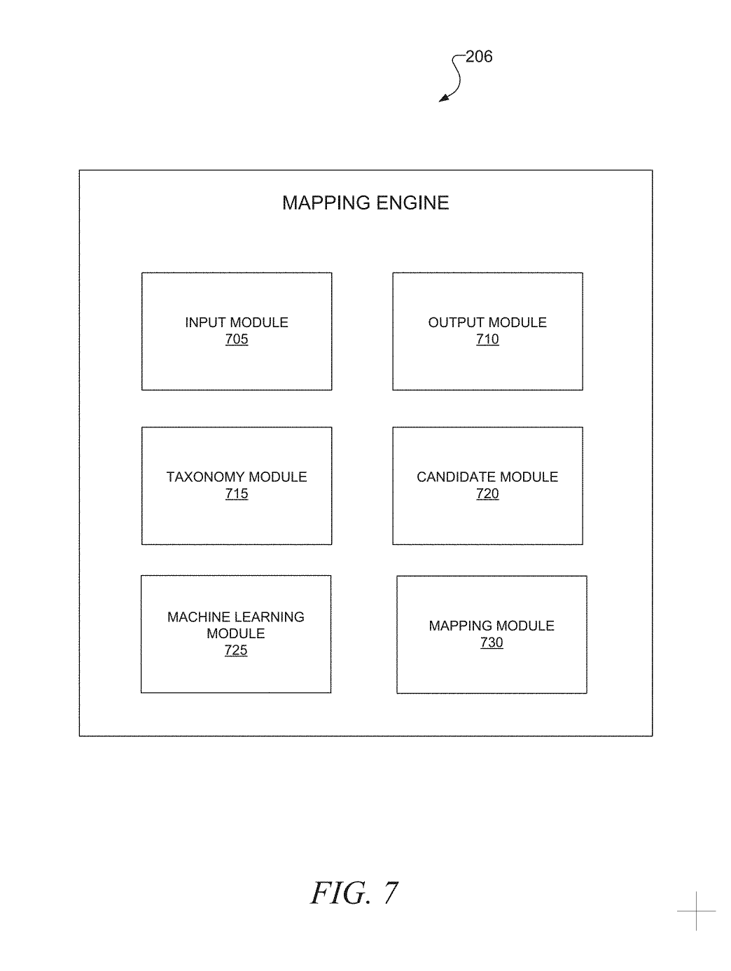

FIG. 7 is a block diagram showing example components of a Mapping Engine 206, according to some embodiments. It is understood that one or more of the modules 705, 710, 715, 720, 725 and 730 of the Mapping Engine 206 perform any of the operations and actions described herein.

The input module 705 is a hardware-implemented module that controls, manages and stores information related to any inputs from one or more components of system 102 as illustrated in FIG. 1 and FIG. 2. In various embodiments, the inputs include raw data and profile data of member accounts, training data.

The output module 710 is a hardware-implemented module that controls, manages and stores information related to which sends any outputs to one or more components of system 100 of FIG. 1 (e.g., one or more client devices 110, 112, third party server 130, etc.). In some embodiments, the output can be a portion of a job title taxonomy, a machine learning model(s), a set of features, a set of candidate job titles, a portion(s) of feature vector data, a probable job title score and a select candidate job title.

The taxonomy module 715 is a hardware implemented module which manages, controls, stores, and accesses information related to building a job title taxonomy, as described herein.

The candidate module 720 is a hardware-implemented module which manages, controls, stores, and accesses information related to identifying one or more candidate job title in a job title taxonomy with respect to a given member account, as described herein.

The machine learning module 725 is a hardware-implemented module which manages, controls, stores, and accesses information related to training and implementing a machine learning model(s), as described herein.

The mapping module 730 is a hardware-implemented module which manages, controls, stores, and accesses information related to creating an association between a member account profile and a job title present in a job title taxonomy, as described herein.

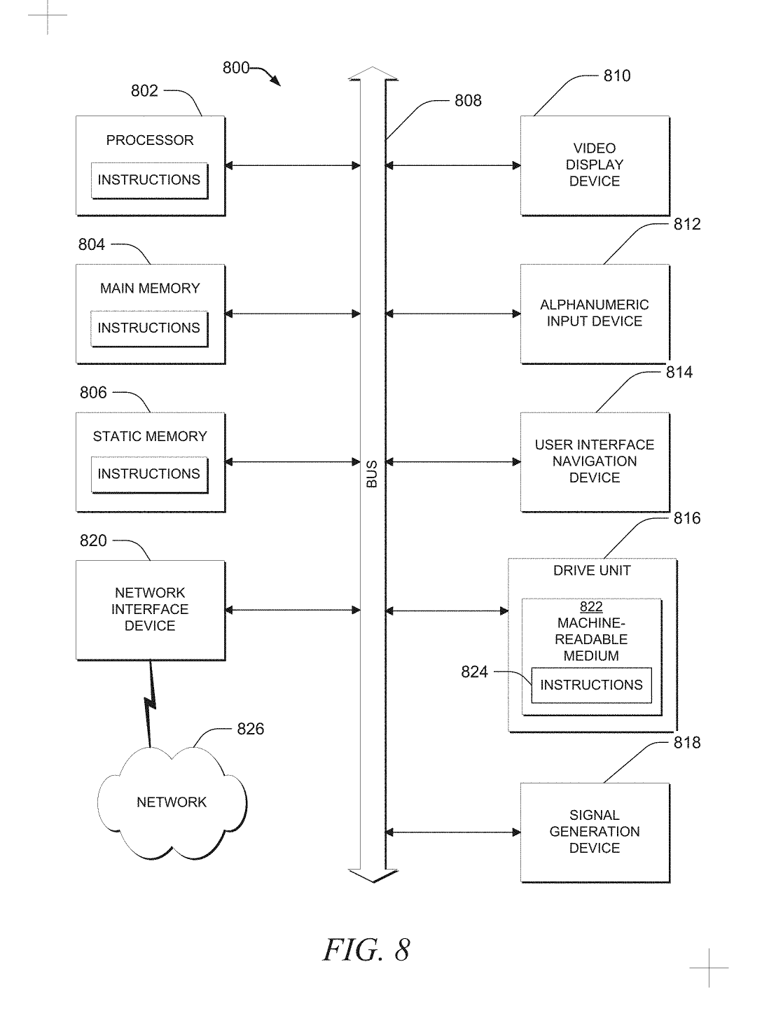

FIG. 8 is a block diagram of a machine in the example form of a computer system 800 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Example computer system 800 includes a processor 802 (e.g., a central processing unit (CPU), a graphics processing unit (GPU) or both), a main memory 804, and a static memory 806, which communicate with each other via a bus 807. Computer system 800 may further include a video display device 810 (e.g., a liquid crystal display (LCD) or a cathode ray tube (CRT)). Computer system 800 also includes an alphanumeric input device 812 (e.g., a keyboard), a user interface (UI) navigation device 814 (e.g., a mouse or touch sensitive display), a disk drive unit 816, a signal generation device 817 (e.g., a speaker) and a network interface device 820.

Disk drive unit 816 includes a machine-readable medium 822 on which is stored one or more sets of instructions and data structures (e.g., software) 824 embodying or utilized by any one or more of the methodologies or functions described herein. Instructions 824 may also reside, completely or at least partially, within main memory 804, within static memory 806, and/or within processor 802 during execution thereof by computer system 800, main memory 804 and processor 802 also constituting machine-readable media.

While machine-readable medium 822 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present technology, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

Instructions 824 may further be transmitted or received over a communications network 826 using a transmission medium. Instructions 824 may be transmitted using network interface device 820 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMAX networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the technology. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer system, comprising:
one or more hardware processors; and
a memory device storing an instruction set executable by the one or more hardware processors that cause the computer system to perform operations comprising:
selecting at least one candidate job title from a portion of a job title taxonomy that corresponds with at least one job title in profile data of a target member account of a social network service;
for each respective candidate job title:
assembling, according to at least one encoded rule of a machine learning model for the respective candidate job title, feature vector data based in part on profile data of the target member account; and
calculating a probable job title score according to the machine learning model for the respective candidate job title;
identifying a select probable job title score from a plurality of probable job title scores;
creating an association between the at least one job title in the profile data of the target member account and a candidate job title that corresponds to the select probable job title score.

2. The computer system as in claim 1, further comprising:
building the portion of the job title taxonomy by creating a taxonomy relationship between a first candidate job title and a second candidate job title; and
wherein selecting at least one candidate job titles from the portion of the job title taxonomy comprises:
identifying at least one shared text segment between the first candidate job title and the at least one job title in the profile data of the target member account;
selecting the first candidate job title based on the at least one shared text segment; and
selecting the second candidate job title based on the taxonomy relationship.

3. The computer system as in claim 2, wherein building the portion of the job title taxonomy by creating a relationship between a first candidate job title and a second candidate job title comprises:
identify a first plurality of member accounts of the social network service with respective profile data that includes a first job title;
identify a first plurality of skills common to the respective profile data of the first plurality of member accounts;
identify a second plurality of member accounts of the social network service with respective profile data that includes a second job title;
identify a second plurality of skills common to the respective profile data of the second plurality of member accounts; and
creating a taxonomy relationship between the first job title and the second job title based on a threshold number of skills shared between the first and the second plurality of skills.

4. The computer system as in claim 3, wherein building the portion of the job title taxonomy occurs in an offline pre-processing mode; and
wherein creating the association between the at least one job title in the profile data of the target member account and a candidate job title that corresponds to the select probable job title score occurs in an online processing mode.

5. The computer system as in claim 1, wherein assembling, according to at least one encoded rule of a machine learning model for the respective candidate job title, feature vector data based in part on profile data of the target member account comprises:
accessing encoded data representative of a feature rule for a type of pre-defined feature;
accessing encoded data representative of at least one attribute of the profile data of the target member account that corresponds with the type of the pre-defined feature;
identifying a regression coefficient associated with the type of the pre-defined feature; and
assembling, according to the feature rule, a portion of the feature vector data for the target member account based on the at least one attribute of the profile data and the regression coefficient.

6. The computer system as in claim 5, wherein accessing encoded data representative of a feature rule for a type of pre-defined feature comprises:
accessing encoded data representative of a feature rule based on aggregate skills tags of a plurality of member accounts with profile data that includes the respective candidate job title.

7. The computer system as in claim 5, wherein accessing encoded data representative of a feature rule for a type of pre-defined feature comprises:
accessing encoded data representative of a feature rule based on aggregate industry designations of a plurality of member accounts with profile data that includes the respective candidate job title.

8. The computer system as in claim 5, wherein accessing encoded data representative of a feature rule for a type of pre-defined feature comprises:
accessing encoded data representative of a feature rule based on aggregate previous job titles of a plurality of member accounts with profile data that includes the respective candidate job title.

9. A computer-implemented method, comprising:
selecting at least one candidate job title from a portion of a job title taxonomy that corresponds with at least one job title in profile data of a target member account of a social network service;
for each respective candidate job title:
assembling, according to at least one encoded rule of a machine learning model for the respective candidate job title, feature vector data based in part on profile data of the target member account; and
calculating, via at least on processor, a probable job title score according to the machine learning model for the respective candidate job title;
identifying a select probable job title score from a plurality of probable job title scores;
creating an association between the at least one job title in the profile data of the target member account and a candidate job title that corresponds to the select probable job title score.

10. The computer-implemented method as in claim 9, further comprising:
building the portion of the job title taxonomy by creating a taxonomy relationship between a first candidate job title and a second candidate job title; and
wherein selecting at least one candidate job titles from the portion of the job title taxonomy comprises:
identifying at least one shared text segment between the first candidate job title and the at least one job title in the profile data of the target member account;
selecting the first candidate job title based on the at least one shared text segment; and
selecting the second candidate job title based on the taxonomy relationship.

11. The computer-implemented method as in claim 10, wherein building the portion of the job title taxonomy by creating a relationship between a first candidate job title and a second candidate job title comprises:
identify a first plurality of member accounts of the social network service with respective profile data that includes a first job title;
identify a first plurality of skills common to the respective profile data of the first plurality of member accounts;
identify a second plurality of member accounts of the social network service with respective profile data that includes a second job title;
identify a second plurality of skills common to the respective profile data of the second plurality of member accounts; and
creating a taxonomy relationship between the first job title and the second job title based on a threshold number of skills shared between the first and the second plurality of skills.

12. The computer-implemented method as in claim 11, wherein building the portion of the job title taxonomy occurs in an offline pre-processing mode; and
wherein creating the association between the at least one job title in the profile data of the target member account and a candidate job title that corresponds to the select probable job title score occurs in an online processing mode.

13. The computer-implemented method as in claim 9, wherein assembling, according to at least one encoded rule of a machine learning model for the respective candidate job title, feature vector data based in part on profile data of the target member account comprises:
accessing encoded data representative of a feature rule for a type of pre-defined feature;
accessing encoded data representative of at least one attribute of the profile data of the target member account that corresponds with the type of the pre-defined feature,
identifying a regression coefficient associated with the type of the pre-defined feature; and
assembling, according to the feature rule, a portion of the feature vector data for the target member account based on the at least one attribute of the profile data and the regression coefficient.

14. The computer-implemented method as in claim 13, wherein accessing encoded data representative of a feature rule for a type of pre-defined feature comprises:
accessing encoded data representative of a feature rule based on aggregate skills tags of a plurality of member accounts with profile data that includes the respective candidate job title.

15. The computer-implemented method as in claim 13, wherein accessing encoded data representative of a feature rule for a type of pre-defined feature comprises:
accessing encoded data representative of a feature rule based on aggregate industry designations of a plurality of member accounts with profile data that includes the respective candidate job title.

16. The computer-implemented method as in claim 13, wherein accessing encoded data representative of a feature rule for a type of pre-defined feature comprises:
accessing encoded data representative of a feature rule based on aggregate previous job titles of a plurality of member accounts with profile data that includes the respective candidate job title.

17. A non-transitory computer-readable medium storing executable instructions thereon, which, when executed by a processor, cause the processor to perform operations including:
selecting at least one candidate job title from a portion of a job title taxonomy that corresponds with at least one job title in profile data of a target member account of a social network service;
for each respective candidate job title:
assembling, according to at least one encoded rule of a machine learning model for the respective candidate job title, feature vector data based in part on profile data of the target member account; and
calculating a probable job title score according to the machine learning model for the respective candidate job title;
identifying a select probable job title score from a plurality of probable job title scores;
creating an association between the at least one job title in the profile data of the target member account and a candidate job title that corresponds to the select probable job title score.

18. The non-transitory computer-readable medium as in claim 17, further comprising:
building the portion of the job title taxonomy by creating a taxonomy relationship between a first candidate job title and a second candidate job title; and
wherein selecting at least one candidate job titles from the portion of the job title taxonomy comprises:
identifying at least one shared text segment between the first candidate job title and the at least one job title in the profile data of the target member account;
selecting the first candidate job title based on the at least one shared text segment; and
selecting the second candidate job title based on the taxonomy relationship.

19. The non-transitory computer-readable medium as in claim 18, wherein building the portion of the job title taxonomy by creating a relationship between a first candidate job title and a second candidate job title comprises:
identify a first plurality of member accounts of the social network service with respective profile data that includes a first job title;
identify a first plurality of skills common to the respective profile data of the first plurality of member accounts;
identify a second plurality of member accounts of the social network service with respective profile data that includes a second job title;
identify a second plurality of skills common to the respective profile data of the second plurality of member accounts; and
creating a taxonomy relationship between the first job title and the second job title based on a threshold number of skills shared between the first and the second plurality of skills.

20. The non-transitory computer-readable medium as in claim 19, wherein building the portion of the job title taxonomy occurs in an offline pre-processing mode; and
wherein creating the association between the at least one job title in the profile data of the target member account and a candidate job title that corresponds to the select probable job title score occurs in an online processing mode.
